(19) United States
(12) Patent Application Publication
(10) Pub. No.: US 2009/0210355 A1
(43) Pub. Date: Aug. 20, 2009

(54) METHOD AND SYSTEM FOR PRODUCING OPTIMIZED PRICES FOR PRODUCTS FOR SALE

(75) Inventors: Paul Dagum, San Francisco, CA (US); Philip David Reginald Apps, San Francisco, CA (US); Leonardo Dagum, Redwood City, CA (US); Michael Joel Goldbach, Albany, CA (US); David Selkirk Wilson, Washington, DC (US); Thomas A. Chavez, San Francisco, CA (US); Nwokoro Duru Ahanotu, Atlanta, GA (US)

Correspondence Address: PERKINS COIE LLP;PATENT-SEA, P.O. BOX 1247, SEATTLE, WA, 98111-1247, US

(73) Assignee: Rapt, Inc., San Francisco, CA (US)

(21) Appl. No.: 12/212,591

(22) Filed: Sep. 17, 2008

Related U.S. Application Data
(63) Continuation of application No. 11/317,350, filed on Dec. 23, 2005, now abandoned.
(60) Provisional application No. 60/638,907, filed on Dec. 23, 2004.

(51) Int. Cl. G06Q 10/00; G06Q 30/00

(52) U.S. Cl. 705/400

(57) ABSTRACT

A computer-implemented method is disclosed. The method includes producing optimized prices for products for sale.

### CROSS REFERENCES TO RELATED APPLICATIONS

This invention claims priority from a provisional application entitled “METHOD AND SYSTEM FOR PRODUCING OPTIMIZED PRICES FOR PRODUCTS FOR SALE” (U.S. Provisional Application No. 60/638,907), filed Dec. 23, 2004, having P. Dagum, P. Apps, L. Dagum, M. Goldbach, D. Wilson, T. Chavez and N. Ahanotu as inventors, and having as assignee Rapt, Inc., the assignee of the present invention. This provisional is incorporated herein by reference in its entirety for all purposes.

### BACKGROUND OF THE INVENTION

1. Field of the Invention

This invention relates generally to the field of dynamic pricing and price optimization. More specifically it relates to a method and an apparatus for determining optimum prices for products for sale by a firm, where the optimum prices are determined to maximize a figure of merit such as revenue, profit, or market share.

2. Description of the Related Art

A firm sells its products, goods and/or services, with the objective of making a profit and/or increasing its market share from the resulting sales. A common lever that controls both profit and market share is the price of the product. The price of the product throughout the product's lifecycle in the market, from new product to end-of-life product, is a key determinant of the product's profitability and market share capture. The link between a product's price and its performance in the market is known as price elasticity. When a product is price-elastic, a 1% decrease (increase) in price gives rise to a greater than 1% increase (decrease) in unit sales. Therefore, a decrease in price for a price-elastic product translates to an increase in both profit and market share. By contrast, when a product is price-inelastic, a 1% decrease (increase) in price gives rise to a less than 1% increase (decrease) in unit sales. In this case, a decrease in price for a price-inelastic product translates to a decrease in profit but an increase in unit sales. In contrast, an increase in price for such a product gives rise to an increase in profit but a decrease in unit sales.

Computing a product's elasticity, or quantifying its unit-sales response to a price change, has challenged and eluded firms for centuries. The first recorded observation of price elasticity was made by Gregory King in 1696 on data collected from London's grain market. King's observations were formalized mathematically by Alfred Marshal in 1890.

Computing a product's elasticity in a globalized manufacturing, financial, and labor economy possess a number of extremely challenging factors that were not addressed by Gregory King or Alfred Marshal's early methods with respect to the elasticity of grain. The available market for a product is time-dependent and geographic- or distribution-channel dependent. Products have rapid lifecycles with multiple near-substitutes entering and leaving the market within any given calendar year. Increasing competition translates to more frequent price and promotions of products. Lastly, products can be purchased with a variety of add-on options. Consumers face a number of purchasing options. These options and the purchasing environment are dynamic, confounding a firm's ability to reliably compute the effect of a price change or competitive price change on unit-sales of a product, unit-sales of its near substitutes, and on bottom line profits.

Without a reliable method for quantifying unit-sales response to a price change, firms base critical product pricing decisions on gut-feel, intuition, and rules-of-thumb. Two common pricing strategies in use are: (i) cost plus, and (ii) competitor minus. The first strategy adds a fixed price increase to the total cost of the product. This strategy attempts to achieve profitability in each product sale. If sales are not sufficient to cover the fixed operational costs of running the firm, this strategy would continue to increase price and thereby further decrease sales, compounding the financial loss.

The second strategy prices the product at some fixed amount less than the competitor's nearest substitute. Commonly, the objective of this strategy is to acquire market share from the competition. Neither method gives a firm the ability to quantify the sales response and profit response from a fixed price increase over cost or decrease over the competition. Without such a quantification, a firm is exposed to the risk of decreased profit and sales from increasing the price of a price-elastic product, or to the risk of decreased profit from decreasing the price of a price-inelastic product. Furthermore, the firm has no ability to compute the prices of the products that it sells over a period of time that maximize a figure of merit such as (i) revenue, (ii) profit; or (iii) market share.

Accordingly, a need exists by firms today for a method that can be used to quantify a firm's unit-sales of products in response to a price change, and to determine the prices that maximize a figure of merit, when the total available market is volatile and time-dependent, when sales of the products and their near substitutes have overlapping lifecycles, and/or when a firm has competitors selling similar products in the market.

### SUMMARY OF THE INVENTION

In one embodiment, a computer-implemented method is disclosed. The method includes producing optimized prices for products for sale.

The foregoing is a summary and thus contains, by necessity, simplifications, generalizations and omissions of detail; consequently, those skilled in the art will appreciate that the summary is illustrative only and is not intended to be in any way limiting. As will also be apparent to one of skill in the art, the operations disclosed herein may be implemented in a number of ways, and such changes and modifications may be made without departing from this invention and its broader aspects. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings.

FIG. 1 is a high-level block diagram of the inputs and outputs to a market-dynamics calculator according to the present invention.

FIG. 2 is a high-level block diagram of the inputs and outputs to a share-of-market calculator according to the present invention.

FIG. 3 is a high-level block diagram of the inputs and outputs to a lifecycle-dynamics calculator according to the present invention.

FIG. 4 is a high-level block diagram of the inputs and outputs to a baseline price calculator according to the present invention, in which the calculations are with respect to the firm's prices.

FIG. 5 is a high-level block diagram of the inputs and outputs to a baseline price calculator according to the present invention, in which the calculations are with respect to the competitors' prices.

FIG. 6 is a high-level block diagram of the inputs and outputs to a sales-response calculator according to the present invention.

FIG. 7 is a high-level block diagram of the inputs and outputs to a SOM-response calculator according to the present invention.

FIG. 8 is a flowchart of a process according to the present invention.

FIG. 9 is a flowchart of a process according to the present invention.

FIG. 10 is a flowchart of a process according to the present invention.

FIG. 11 is a flowchart of a process according to the present invention.

FIG. 12 is a flowchart of a process according to the present invention.

FIG. 13 is a block diagram illustrating a network environment in which processing according to embodiments of the present invention may be practiced.

FIG. 14 is a block diagram illustrating a computer system suitable for implementing embodiments of the present invention.

FIG. 15 is a block diagram illustrating the interconnection of the computer system of FIG. 2 to client and host systems.

The use of the same reference symbols in different drawings indicates similar or identical items.

### DETAILED DESCRIPTION OF THE INVENTION

The following is intended to provide a detailed description of an example of the invention and should not be taken to be limiting of the invention itself. Rather, any number of variations may fall within the scope of the invention which is defined in the claims following the description.

### Introduction

The present invention provides a method and system that allows a user to quantify the unit-sales responses to price changes for a firm's products, in the situation in which the total available market is volatile and time-dependent. The present invention can also be used to quantify the unit-sales responses to price changes for a firm's products when sales of the products and their near substitutes have overlapping lifecycles. The present invention also allows unit-sales responses to price changes for a firm's products, in the situation in which a firm has competitors selling similar products in the market, to be quantified. The present invention can be used to price products for a firm in order to maximize a figure of merit such as revenue, profit, or market share. The present invention allows a firm to price products in a way that maximize a figure of merit such as revenue, profit, or market share subject to business constraints applicable to prices and inventory.

The present invention allows for the quantification of a firm's product sales in response to a price change, and the determination of the prices that maximize a figure of merit, when the total available market is volatile and time-dependent, in the situation in which sales of the products and their near substitutes have overlapping lifecycles, and/or in the situation in which a firm has competitors selling similar products in the given market.

In employing a method and system of the present invention, a method is used in making future predictions of the total-available market (or TAM). This method can be based subjective assessments of the TAM predictions, or a forecasting model that takes as input historical TAM values to forecast future TAM values can be employed, for example. These predictions can take into consideration seasonality and other business cycles that affect the available market for the products sold by the firm. Furthermore, it will be appreciated that the global available market for the firms' products can be segmented into multiple regional markets or into distinct channels, and each such segmentation can be treated separately in the practice of this invention.

A method is then employed in making future predictions of the share-of-market (SOM), or fraction of the TAM, represented by the firm's product sales. This method can take as input historical SOM values to forecast future SOM values, for example. Similar to the TAM predictions, SOM predictions can also incorporate seasonality and business cycles when these are prominent in the data.

Historical product sales are computed for the firm, as a percent of SOM. A method is then selected for use in making future predictions of product sales as percent of SOM from the historical computed values. Computing historical product sales as a percent of SOM reveals each product's lifecycle curve and makes possible the prediction of future sales using methods known to those of ordinary skill in the art. Lifecycles are not clearly evident in the raw product sales data because the time-dependent TAM and SOM trends, and respective seasonalities and business cycles, can mask these lifecycles.

Future baseline prices are computed for its products and its competitors' products. The baseline price for a product represents what a consumer expects to pay for that product at that time. A consumer's rational expectation of the fair-market value for a product is anchored on historical prices for that product, how those prices have been trending, possibly on competitor's prices, and on perceived product value. Using historical price data and the appropriate product specific parameters and descriptors, the firm computes future baseline prices for its products and for its competitors' products.

The change in price from the firm's future planned prices and the baseline prices for each product is then computed. Such price changes are similarly computed for the firm's competitors based on a scenario-based assumption of the competitors' planned prices. When a planned price is higher than the baseline price (a positive price change), the firm receives lower than expected sales for that product, and possibly higher than expected sales for near-substitute products. Conversely, when a planned price is lower than expected (a negative price change), the firm receives higher than expected sales for that product and correspondingly lower than expected sales for near-substitutes. An econometric model that quantifies the adjustments to product sales as percent of SOM on account of price changes made by both the firm and its competitors, is employed. The effect of the price changes on the firm's SOM is then computed, again by selecting an econometric model that quantifies SOM adjustments relative to price changes.

The above processes according to the present invention provide a method to quantify a firm's product sales in response to a price change when the total available market is volatile and time-dependent, when sales of the products and their near substitutes have overlapping lifecycles, and/or when a firm has competitors selling similar products in the market.

The present invention then enables the computation of prices for the firm's products that maximize revenue (resp. profit) subject to business constraints such as lower and upper bounds on the firm's prices and its inventory. The constrained optimization method to employ for computing the prices that maximize revenue or profit objectives is then selected. The ability to compute prices that maximize the firm's market share will also be apparent from this disclosure to those skilled in the art. The ability to compute prices that maximize a figure of merit calculated from unit sales, prices, costs and other econometric quantities related to the products for sale will also be apparent to those skilled in the art, in light of the techniques described in the present disclosure.

### Symbol Definitions

Symbols used at various points, and in various equations herein are defined as follows:

mₜ≡total available market (TAM) at time t

sₜ≡share-of-market (SOM) at time t

ŝₜ≡price-adjusted share-of-market (SOM) at time t

x_{i,t}≡sales of product i at time t

\hat{x}_{i,t}≡price-adjusted sales of product i at time t

z_{i,t}≡percent sales of product i at time t

\hat{z}_{i,t}≡a price-adjusted percent sales of product i at time t

p_{i,t}≡price of product i at time t

p̅_{i,t}≡baseline price of product i at time t

Δp_{i,t}≡price change for product i at time t

c_{i,t}≡cost of product i at time t

q_{k,i,t}≡competitor k's price of product i at time t

q̅_{k,i,t}≡competitor k's baseline price of product i at time t

Δq_{k,i,t}≡competitor k's price change for product i at time t

lp_{i,t}≡lower bound price of product i at time t

up_{i,t}≡upper bound price of product i at time t

lx_{i,t}≡lower bound inventory of product i at time t

ux_{i,t}≡upper bound inventory of product i at time t

rₜ≡revenue at time t

πₜ≡profit at time t

Γ_{i,j,t}≡elasticity parameter for sales of product i with respect to prices of product i and product j at time t

Γ^{S}_{i,t}≡elasticity parameter for SOM with respect to price of product i at time t

Nₜ≡number of products in the market at time t

Mₜ≡number of competitive products in the market at time t

### The Production of Optimized Prices for Products for Sale

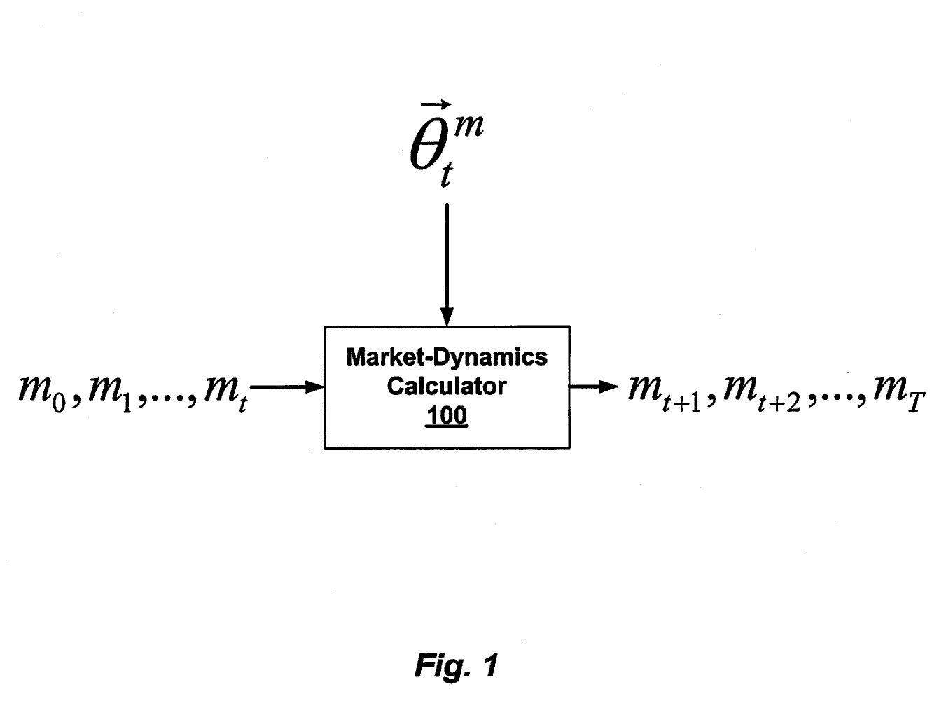

FIG. 1 is a high-level block diagram of the inputs and outputs to a market-dynamics calculator 100 according to the present invention. FIG. 1 depicts a process according to the present invention for producing prices of products for sale that maximize a figure of merit. This process produces future predictions of the total available market (TAM) known to those of ordinary skill in the art and defined as the sum total of all products with specific characteristics that are consumed within a defined market such as a geography or a distribution channel. This operation takes as inputs the historical TAM values m₀, m₁, . . . , mₜ and a vector of parameters \vec{θ}ₜ^{m} that is specific to the forecasting method chosen in this operation. This operation outputs future TAM values mₜ₊₁, mₜ₊₂, . . . , M_{T}. The method of forecasting used can include any one of a number of forecasting methods. Examples of such forecasting methods include, but are not limited to, linear extrapolation models, exponential smoothing models, auto-regressive integrated moving average (ARIMA) models and the like.

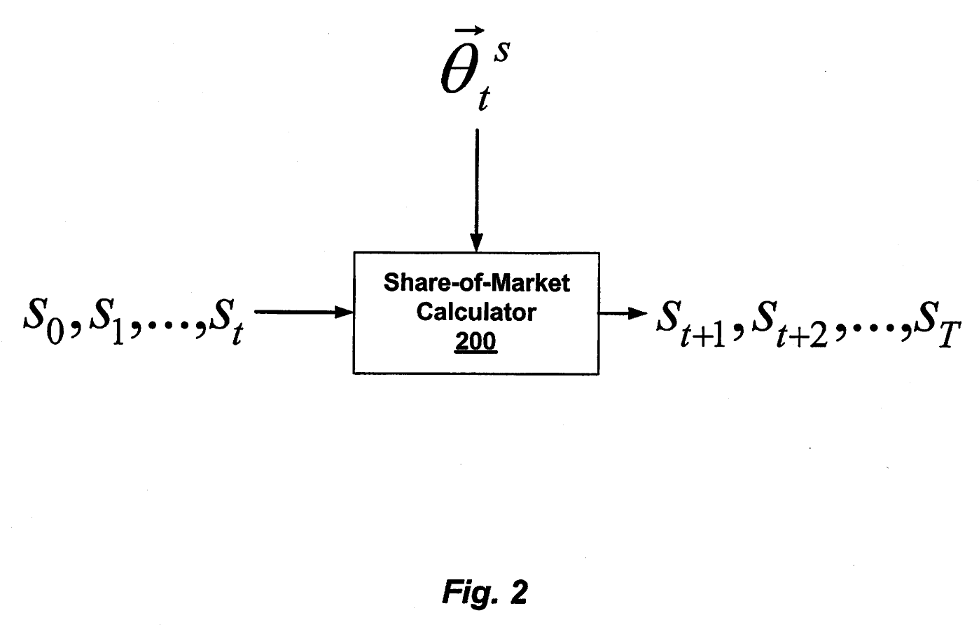

FIG. 2 is a high-level block diagram of the inputs and outputs to a share-of-market calculator 200 according to the present invention. FIG. 2 depicts a process according to the present invention for producing prices of products for sale that maximize a figure of merit. This process produces future predictions of the company's share-of-market (SOM) defined as the sum total of all company product sales of defined characteristics divided by the TAM for those products for a defined market, geography or distribution channel:

$${s}_{i} = \frac{{\sum }_{i = 1}^{n} {x}_{i , t}}{{m}_{i}}$$

This operation takes as inputs the historical SOM s₀, sₜ, . . . , s₁ and a vector of parameters \vec{θ}ₜ^{s} that is specific to the forecasting method chosen in this operation. This operation outputs future SOM values sₜ₊₁, sₜ₊₂, . . . , s_{T}. The method of forecasting used can include any one of a number of forecasting methods. Examples of such forecasting methods include, but are not limited to, linear extrapolation models, exponential smoothing models, ARIMA models and the like.

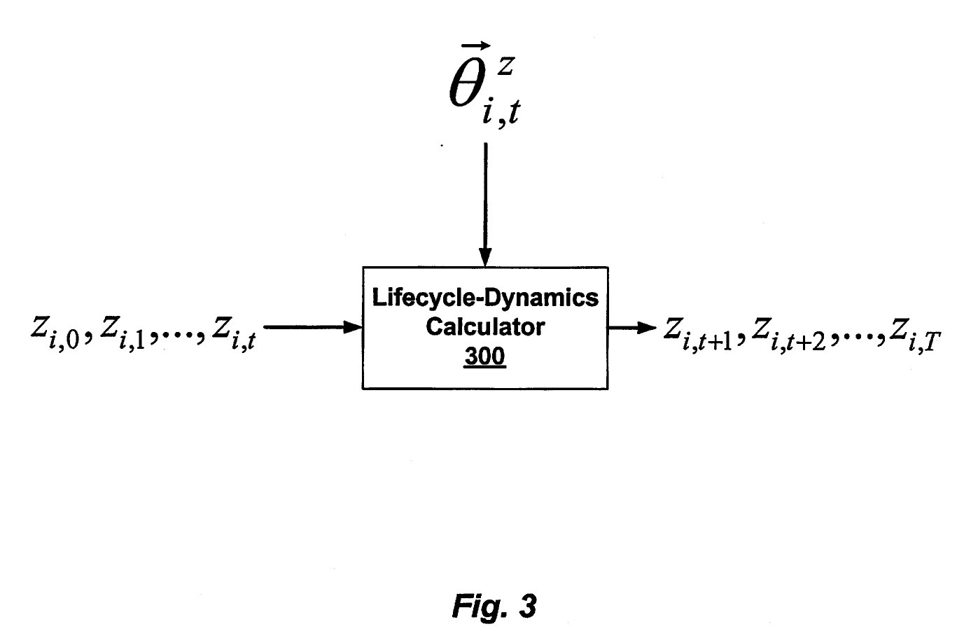

FIG. 3 is a high-level block diagram of the inputs and outputs to a lifecycle-dynamics calculator 300 according to the present invention. FIG. 3 depicts a process according to the present invention for producing prices of products for sale that maximize a figure of merit. This process produces future predictions of percent sales of SOM for each product sold by the company. For the i^{th} product, this operation takes as inputs the historical values of this product's percent sales of SOM z_{i,0}, z_{i,1}, . . . , z_{i,t} defined as the company's product i sales divided by that product group's SOM:

$${z}_{i , t} = \frac{{x}_{i , t}}{{s}_{t}}$$

Additionally, this operation takes as input a vector of parameters \vec{θ}_{i,t}^{z} specific to each product and to the forecasting method chosen in this operation. With these inputs for product i, this operation outputs future percent sales of SOM values z_{i,t+1}, z_{i,t+2}, . . . , z_{i,T}. This operation is executed for all N₁ products sold by the company at time t that contribute to the SOM computation of operation two. In the manner previously noted, the method of forecasting used can include any one of a number of forecasting methods. Examples of forecasting methods particularly useful for forecasting percent sales of products with lifecycles include Bass curves and the like.

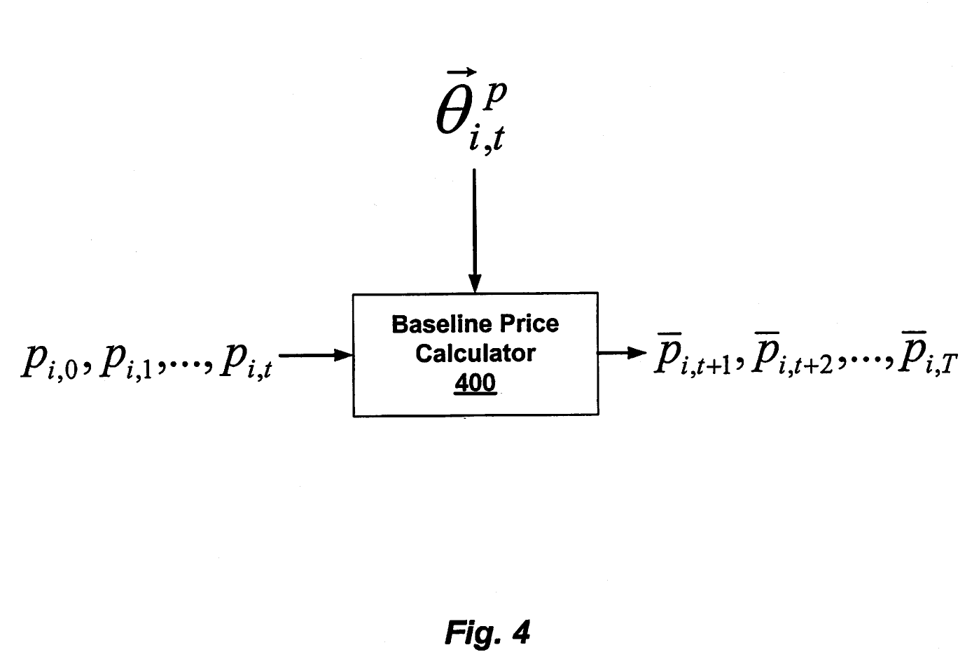

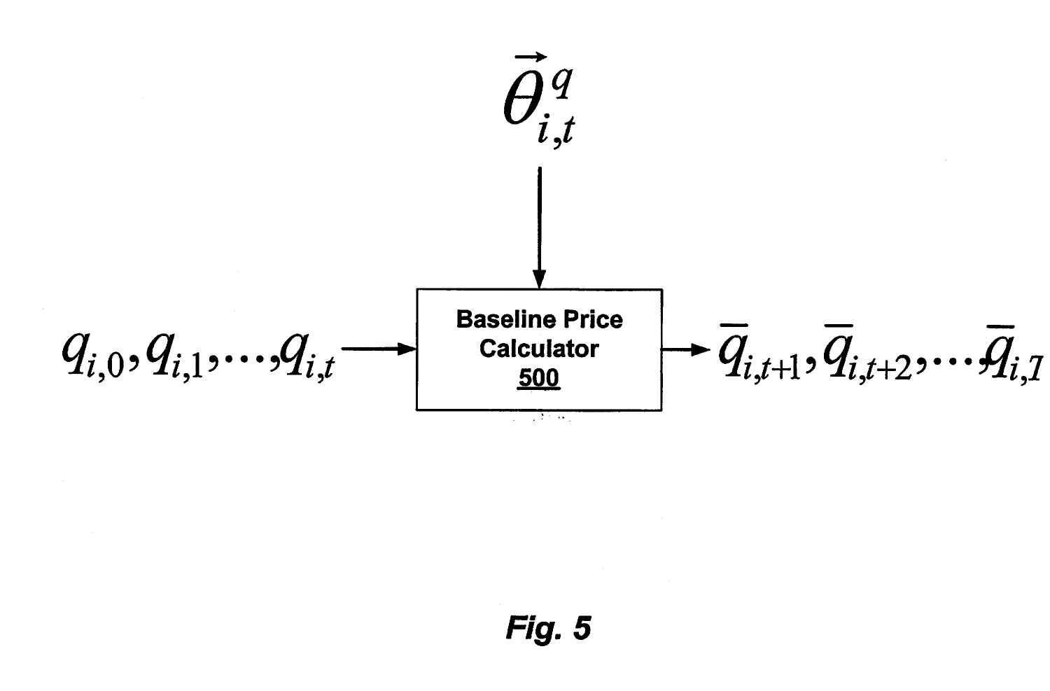

FIG. 4 is a high-level block diagram of the inputs and outputs to a baseline price calculator 400 according to the present invention, in which the calculations are with respect to the firm's prices. FIG. 5 is a high-level block diagram of the inputs and outputs to a baseline price calculator 500 according to the present invention, in which the calculations are with respect to the competitors' prices.

FIGS. 4 and 5 depict processes according to the present invention for producing prices of products for sale that maximize a figure of merit. These processes produce future predictions of a baseline product price for each product sold by the company. In FIG. 4, for the i^{th} product this process takes as inputs the historical product i prices p_{i,0}, p_{i,1}, . . . , p_{i,t} a vector of parameters \vec{θ}_{i,t}^{p} specific to the i^{th} product and to the forecasting method chosen for this process. This process outputs future baseline prices p̅_{i,t+1}, p̅_{i,t+2}, . . . p̅_{i,T}. This process is executed for the prices of all Nₜ products sold by the company at time t that contribute to the SOM computation of the process of FIG. 2. Additionally, in second mode of carrying out this invention as shown in FIG. 5, this process is also executed for the prices of all Mₜ products sold by the company's competitors for which historical pricing data is available, or assumed via a scenario-based approach, and that compete for sales with one or more of the company's Nₜ products. Thus, an additional output from this process is the future baseline prices of the competitor's products q̅_{i,t+1}, q̅_{i,t+2}, . . . , q̅_{i,T}. As previously noted, the method of forecasting used can include any one of a number of forecasting methods. Examples of such forecasting methods include, but are not limited to, linear extrapolation models, exponential smoothing models, ARIMA models and the like.

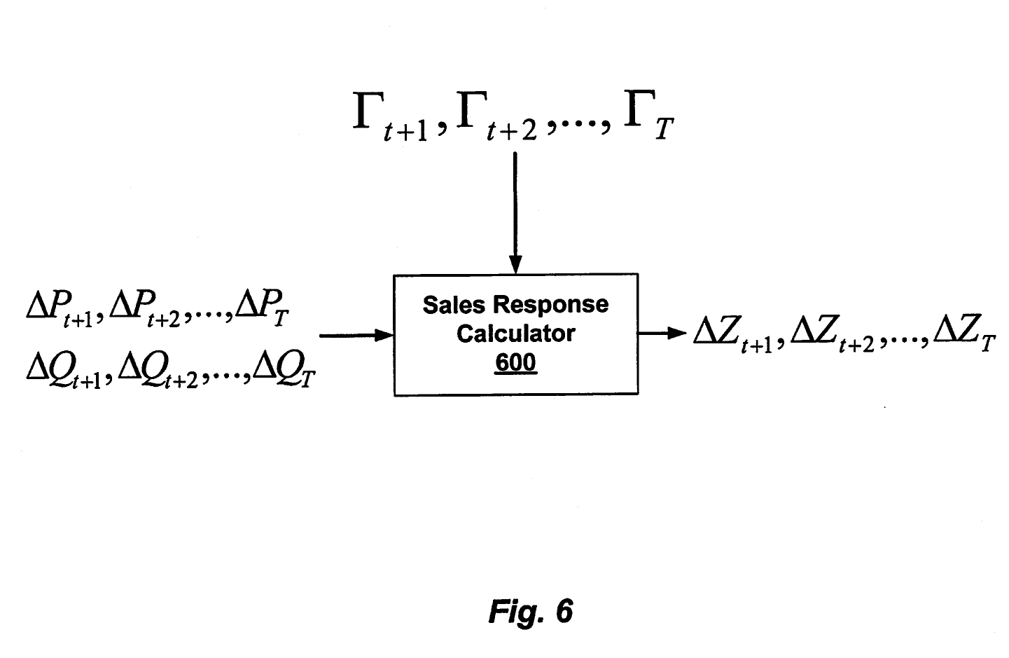

FIG. 6 is a high-level block diagram of the inputs and outputs to a sales-response calculator 600 according to the present invention. FIG. 6 depicts a process according to the present invention for producing prices of products for sale that maximize a figure of merit. This process adjusts the percent sales for each product computed in the process of FIG. 3 if the future price plan for a product differs from the baseline price plan of that product computed in the processes of FIG. 4 or 5. For the i^{th} product sold by the company, the difference between the planned price p_{i,t} and the baseline price p̅_{i,t} computed in the process of FIG. 4 is the price change:

Δp_{i,t}=p_{i,t}− p̅_{i,t} Δp_{i,t}=p_{i,t}− p̅_{i,t}

The price change for the i^{th} competitor's product is similarly defined

Δq_{i,t}=q_{i,t}− q̅_{i,t}

The inputs ΔPₜ₊₁, ΔPₜ₊₂, . . . , ΔP_{T} in FIG. 6 are vectors containing the company's price changes from the baseline price predictions computed in the process of FIG. 4 for all Nₜ products and for times t+1 through T. The inputs ΔQₜ₊₁, ΔQ₁₊₂, . . . , ΔQ_{T} are vectors containing the competitors price changes from the baseline prices computed in the process of FIG. 4 for all Mₜ competitors' products and for times t+1 through T. The inputs Γₜ₊₁, Γₜ₊₂, . . . , Γ_{T} are vectors of the elasticity parameters Γ_{i,j,t} where the index i runs over the company's Nₜ products and the index j runs over both the company's Nₜ products and the competitors' Mₜ products. As shown in FIG. 6, this process outputs the vectors ΔZₜ₊₁, ΔZₜ₊₂, . . . , ΔZ_{T} where ΔZₜ₊ₖ contains a vector of adjustments Δz_{i,t+k} (where i runs over Nₜ) to the predictions of percent sales of SOM for the i^{th} product sold by the company as computed in the process of FIG. 3. The price-adjusted percent sales of SOM for the i^{th} product at time i+k is computed as:

\hat{z}_{i,t+k}=z_{i,t+k}+Δz_{i,t+k}

In the manner previously noted, the method of econometric forecasting used can include any one of a number of forecasting methods. Examples of such forecasting methods include, but are not limited to, multivariate linear regression models, random coefficients models, random utilities models and the like.

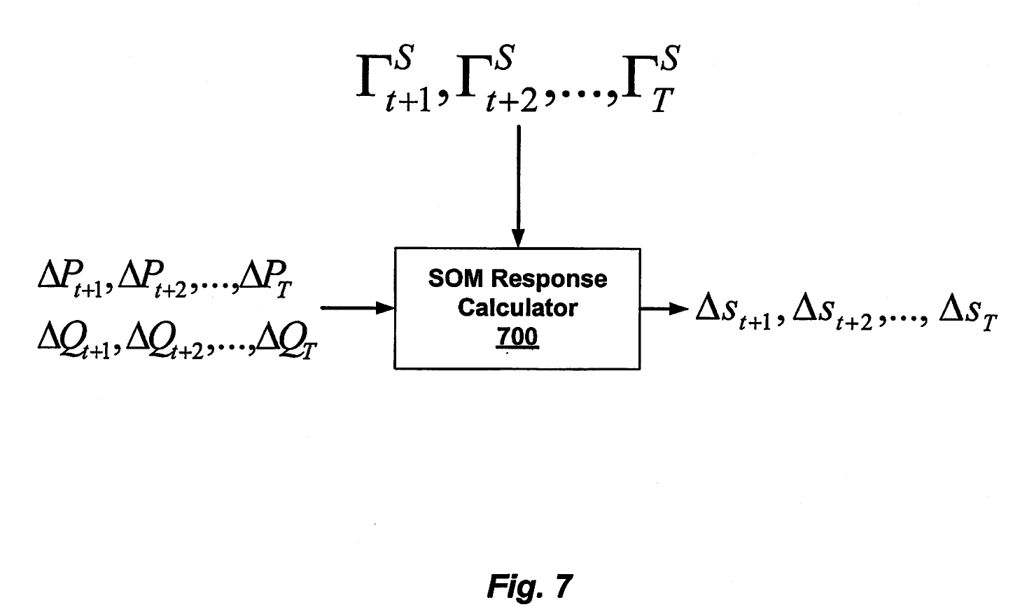

FIG. 7 is a high-level block diagram of the inputs and outputs to an SOM-response calculator 700 according to the present invention. FIG. 7 depicts a process according to the present invention for producing prices of products for sale that maximize a figure of merit. This process adjusts the SOM computed in the process of FIG. 2 if the future price plan for the company's or its competitors' products differ from the baseline price plans computed in the process of FIG. 4. The inputs ΔPₜ₊₁, ΔPₜ₊₂, . . . , ΔP_{T} and ΔQₜ₊₁, ΔQₜ₊₂, . . . , ΔQ_{T} in FIG. 7 are the same inputs as in FIG. 6. The inputs Γₜ₊₁^{S}, Γₜ₊₂^{S}, . . . , Γ_{T}^{S} are vectors of the SOM elasticity parameters Γ^{S}_{i,t} where the index i runs over the company's Nₜ products. As shown in FIG. 7, this process outputs the Δsₜ₊₁, Δsₜ₊₂, . . . Δs_{T} where Δsₜ₊ₖ contains the adjustment at time t+k to the prediction of SOM computed in the process of FIG. 2. The price-adjusted SOM at time t+k is computed as:

ŝₜ₊ₖ=sₜ₊ₖ+Δsₜ₊ₖ

As previously noted, the method of econometric forecasting used can include any one of a number of forecasting methods. Examples of such forecasting methods include, but are not limited to, multivariate linear regression models, random coefficients models, random utilities models and the like.

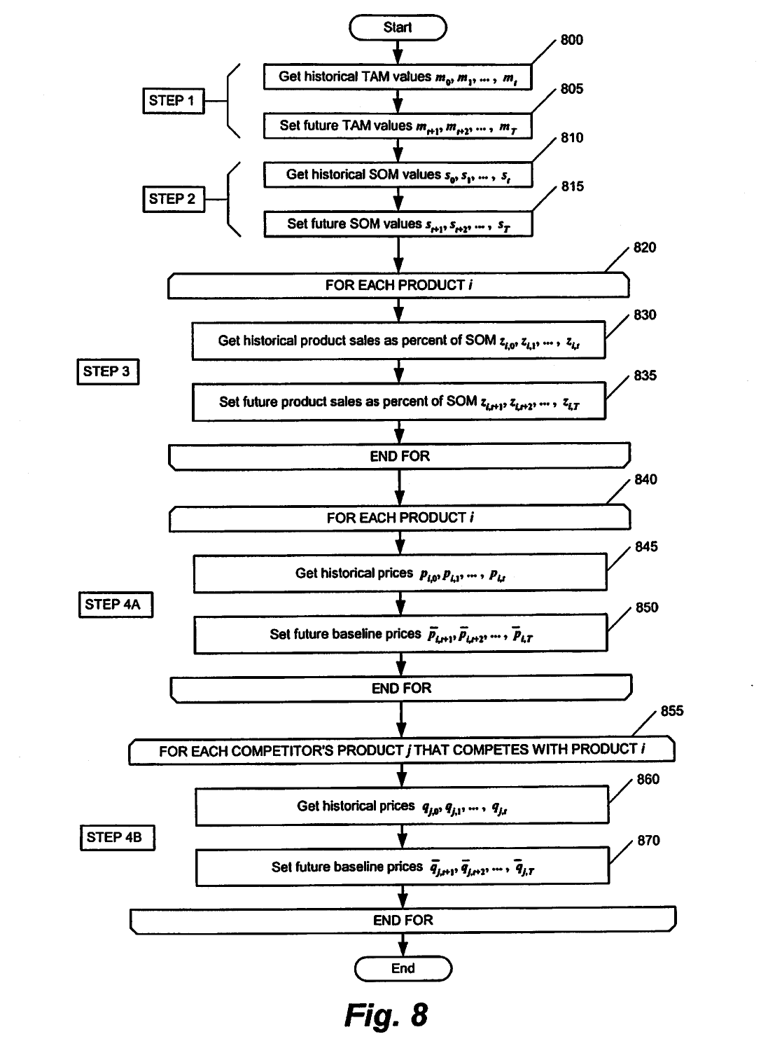

FIGS. 8, 9, and 10 depict a summarization of the processes depicted in FIGS. 1, 2, 3, 4, 5 and 6. FIGS. 8, 9, and 10 depict processes according to the present invention for producing prices of products for sale that maximize a figure of merit. Multiplication of the computed values of the TAM, the price-adjusted SOM, and the price-adjusted percent sales of SOM for each product and for each future period gives the price-adjusted future sales for each product:

FIG. 8 is a flowchart of a process according to the present invention. The process begins with the obtaining of historical TAM values (step 800) and the setting of future TAM values (steps 800 and 805, respectively). These operations are designated STEP 1 in FIG. 8. Methods for performing these operations can employ forecasting procedures such as those described earlier. Next, historical SOM values and future SOM values are obtained and set, respectively (steps 810 and 815, respectively). These operations are designated STEP 2 in FIG. 8. Again, methods for performing these operations can employ forecasting procedures such as those described earlier. In the operations designated as STEP 3 in FIG. 8, for each product i used in STEP 2 (step 820), an historical product sales as percent of SOM is obtained (step 830), and future product sales as percent of SOM is set (step 835). Once again, methods for performing these operations can employ forecasting procedures such as those described earlier.

In the operations designated as STEP 4A in FIG. 8, for each product i used in STEP 2 (step 840), historical prices are obtained (step 845), and future baseline prices are set (step 850). Yet again, methods for performing these operations can employ forecasting procedures such as those described earlier. In the operations designated as STEP 4B in FIG. 8, for each competitor's product i that competes with products in STEP 2 (step 855), historical prices are obtained (step 860), and future baseline prices are set (step 870). Once again, methods for performing these operations can employ forecasting procedures such as those described earlier.

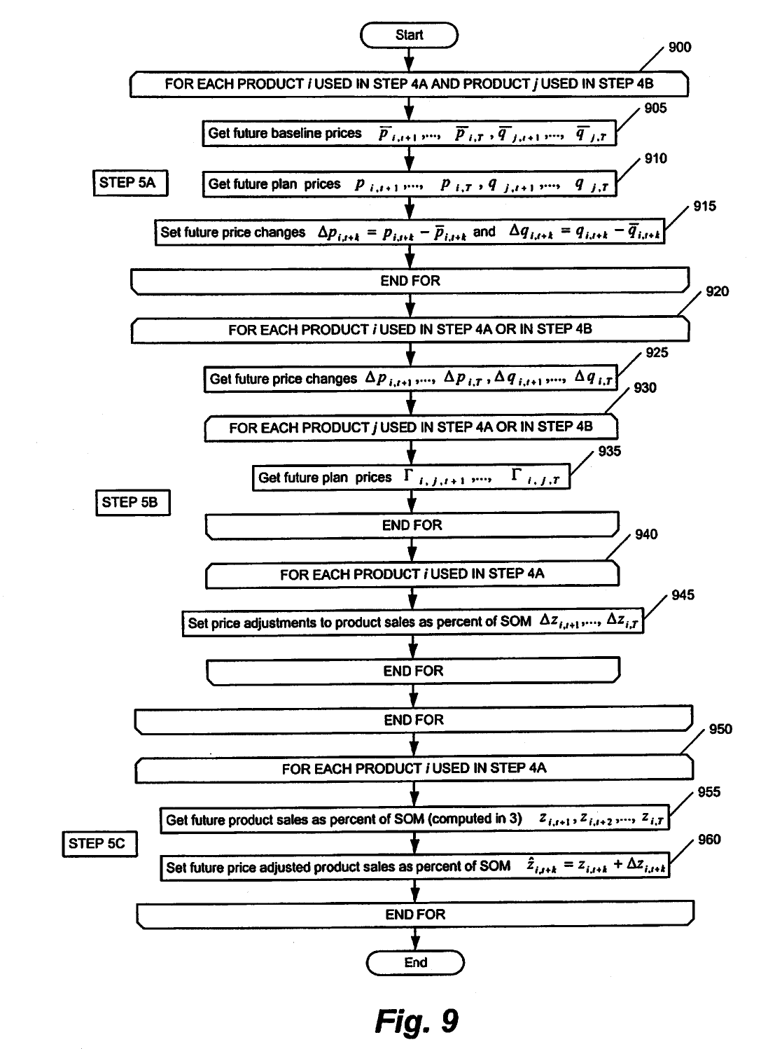

FIG. 9 is a flowchart of a process according to the present invention. In the operations designated as STEP 5A in FIG. 9, for each product i used in STEP 4A and product j used in STEP 4B (step 900), future prices are obtained (step 905), future plan prices are obtained (step 910), and future price changes are set (step 915). In the operations designated as STEP 5B in FIG. 9, for each product i used in STEP 4A or in STEP 4B (step 920), several operations are performed. First, future price changes computed in STEP 5A are obtained (step 925). Then, for each product j used in STEP 4A and in STEP 4B (step 930), future plan prices are obtained (step 935). Then, for each product i used in STEP 4A (step 940), future price adjustments to product sales as percent of SOM are set (step 945). This concludes the operations designated as STEP 5B in FIG. 9. In the operations designated as STEP 5C in FIG. 9, for each product i used in STEP 4A (step 950), future product sales as percent of SOM computed in STEP 3 are obtained (step 955) and future price adjusted product sales as percent of SOM are set) step 960.

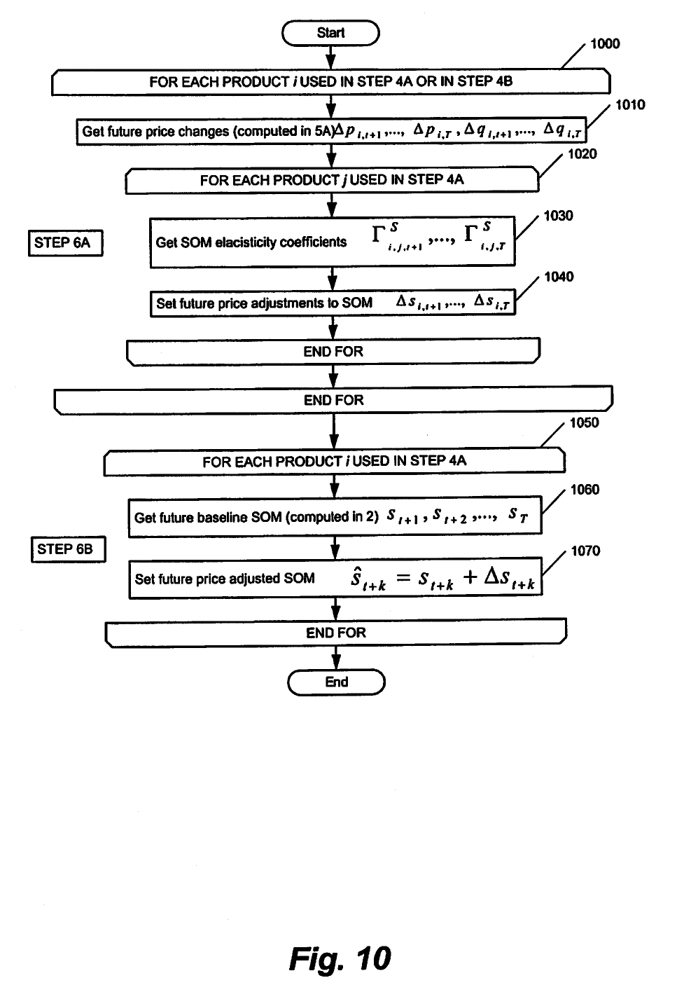

FIG. 10 is a flowchart of a process according to the present invention. In the operations designated as STEP 6A in FIG. 10, for each product i used in STEP 4A or in STEP 4B (step 1000), several operations are performed. First, future price changes computed in STEP 5A are obtained (step 1010). Then, for each product j used in STEP 4A (step 1020), SOM elasticity coefficients are obtained (step 1030), and future price adjustments to SOM are set (step 1040). Methods of econometric forecasting can be used in this regard, as discussed earlier herein. In the operations designated as STEP 6B in FIG. 10, for each product i used in STEP 4A (step 1050), the future price adjusted SOM is obtained (step 1060), and the future price adjusted SOM is set (step 1070).

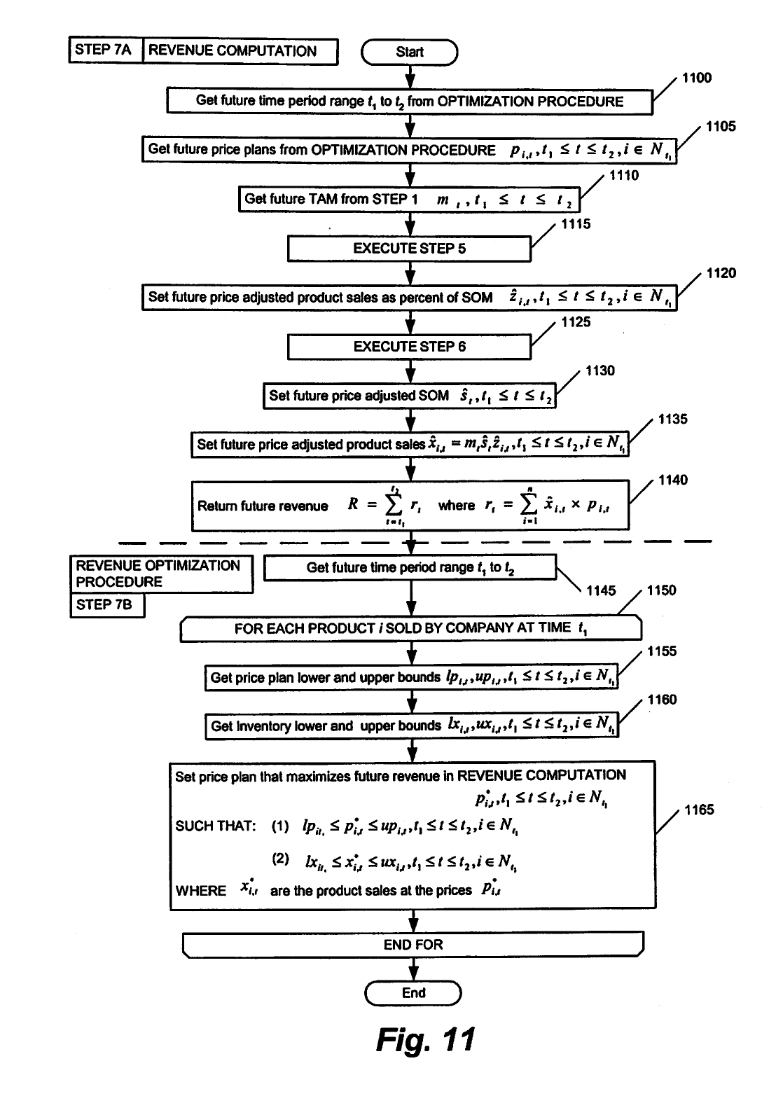

FIG. 11 is a flowchart of a process according to the present invention. FIG. 11 depicts a process according to the present invention for producing prices of products for sale that maximize a figure of merit. This process uses future revenue at time t as the figure of merit. This quantity is computed as:

$${r}_{t} = {\sum }_{i = 1}^{n} {\hat{x}}_{i , t} \times {p}_{i , t}$$

with total revenue for periods t₁≦t≦t₂ given by:

$$R = {\sum }_{t = {t}_{1}}^{{t}_{2}} {r}_{t}$$

This process finds prices for the products that the company sells that maximize the company's revenue from those products. This process takes as input the future time period of interest, t₁,t₂, and, for each product and each time, the lower and upper price bounds lp_{i,t}, up_{i,t},t₁≦t≦t₂,iεNₜ_{₁} and the lower and upper inventory bounds lx_{i,t}, ux_{i,t},t₁≦t≦t₂,iεNₜ_{₁}. There is no loss in generality by requiring bounding constraints on all price and inventory because a constraint can be made non-binding by setting an upper bound to infinite and a lower bound to negative infinite. The process of FIG. 11 outputs the price plan that maximizes the revenue computed by the method of this process. The output price plan p_{i,t}*, t₁≦t≦t₂,iεNₜ_{₁} satisfies the lower and upper bound price constraints, and the product sales at this price plan x_{i,t}*, t₁≦t≦t₂,iεNₜ_{₁} satisfy the lower and upper bound inventory constraints.

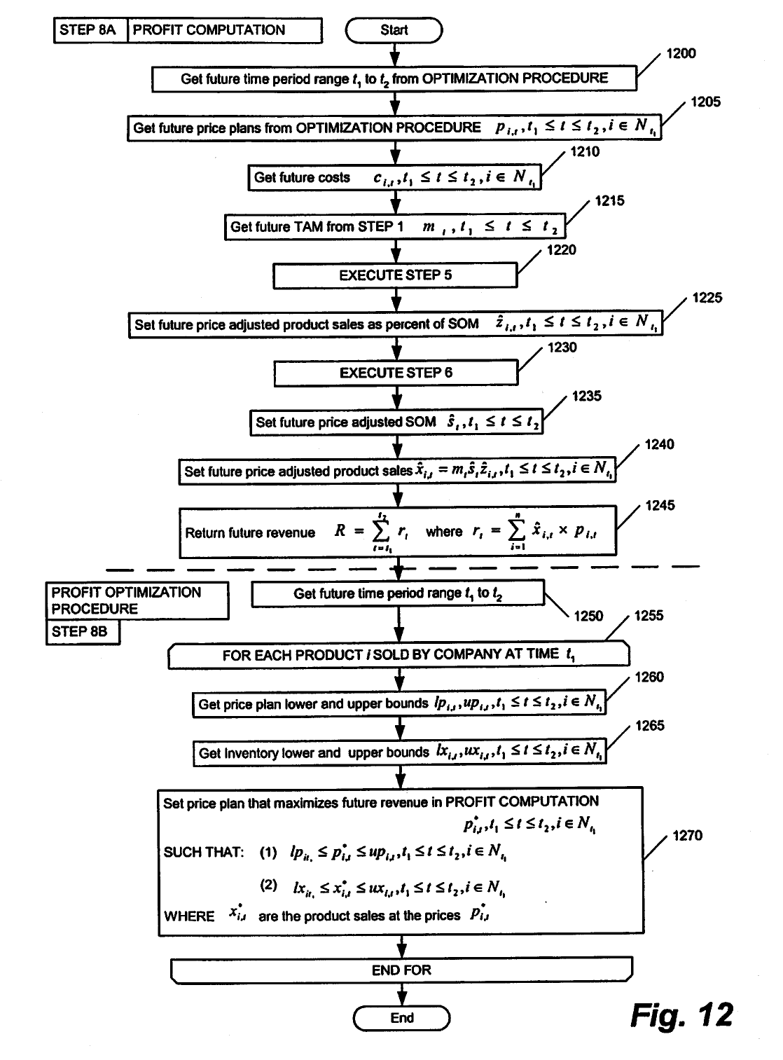

FIG. 12 is a flowchart of a process according to the present invention. FIG. 12 depicts a process according to the present invention for producing prices of products for sale that maximize a figure of merit. This process uses future profit as the figure of merit. The future profit at time t is computed as:

$${π}_{t} = {r}_{t} - {\sum }_{i = 1}^{n} {\hat{x}}_{i , t} \times {c}_{i , t}$$

with total profit for periods t₁≦t≦t₂ given by:

$$Π = {\sum }_{t = {t}_{1}}^{{t}_{2}} {π}_{t}$$

This process finds prices for the products that the company sells that maximize the company's revenue from those products. This process takes as input the future time period of interest, t₁, t₂, and, for each product and each time, the lower and upper price bounds lp_{i,t}, up_{i,t}, t₁≦t≦t₂,iεNₜ_{₁} and the lower and upper inventory bounds lx_{i,t}, ux_{i,t}, t₁≦t≦t₂,iεNₜ_{₁}. There is no loss in generality by requiring bounding constraints on all price and inventory because a constraint can be made non-binding by setting an upper bound to infinite and a lower bound to negative infinite. The process of FIG. 12 outputs the price plan that maximizes the profit computed by the method in this process. In both processes, the output price plan p_{i,t}*,t₁≦t≦t₂,iεNₜ_{₁} satisfies the lower and upper bound price constraints, and the product sales at this price plan x_{i,t}*,t₁≦t≦t₂,iεNₜ_{₁} satisfy the lower and upper bound inventory constraints.

Determining prices for the products that the firm sells that maximize the firm's market share for those products is apparent from this disclosure to those skilled in the art. Replacing the figure of merit of the process of FIG. 11 with:

$${s}_{t} = {\sum }_{i = 1}^{n} {\hat{x}}_{i , t}$$

and proceeding with the optimization method disclosed in this process produces prices that maximize the company's market share. Determining prices for the products that the firm sells that maximize a figure of merit computed from sales volume, prices, costs and other econometric quantities for those products will be apparent to those skilled in the art in light of the present disclosure.

### EXAMPLES

In order to illustrate the operation of the invention we consider a simplified example. Table 1 shows two companies, ACME and XYZ, that sell cellular phones. Each company sells three phone models with increasing functionality from the basic model to the newest model, as shown in Table 1. ACME Co. sells phones A01, A02, and A03, and XYZ Co. sells phones X11, X12, and X13. This example assumes for illustrative simplicity that both companies sell their products into the same market. Table 2 shows sales and price data for ACME's products from January to July. This table also contains the product prices of ACME's competitor, XYZ Co., and the monthly total-available market, or TAM, for the cell-phone market. The TAM includes products sales for all three models of cell phones sold by both ACME and XYZ. ACME may have additional competitors and the TAM additionally includes the sales of these cell phones.

TABLE 1

| | | |
|---|---|---|
| ACME Co. | Cell Phone A01 | Black & White |
| | Cell Phone A02 | Color Display |
| | Cell Phone A03 | Vision Picture |
| XYZ Co. | Cell Phone X11 | Black & White |
| | Cell Phone X12 | Color Display |
| | Cell Phone X13 | Vision Picture |

TABLE 2

| | | | | | ACME | | | | | | |
|---|---|---|---|---|---|---|---|---|---|---|---|
| | | A01 | A02 | A03 | Sales | A01 | A02 | A03 | X11 | X12 | X13 |
| MONTH | TAM | Sales | Sales | Sales | Total | Price | Price | Price | Price | Price | Price |
| January | 100 | 20 | 5 | 0 | 25 | $100 | $150 | | $120 | $170 | |
| February | 120 | 21 | 9 | 0 | 30 | $100 | $150 | | $120 | $170 | |
| March | 140 | 17 | 13 | 0 | 30 | $80 | $120 | | $120 | $140 | |
| April | 130 | 15 | 20 | 0 | 35 | $80 | $120 | | $90 | $140 | |
| May | 150 | 13 | 27 | 0 | 40 | $80 | $120 | | $90 | $110 | |
| June | 140 | 8 | 24 | 2 | 35 | $60 | $100 | $150 | $40 | $110 | $130 |
| July | 160 | 8 | 29 | 8 | 45 | $40 | $80 | $140 | $40 | $110 | $120 |

Given a price plan for products A01, A02, and A03 for the months of August, September, October, November, and December, and a best-guess price plan for the competitor's products X11, X12, and X13 for these same months, an objective of this invention is to produce monthly sales estimates for products A01, A02, and A02 from August through December. A method of the present invention for producing these sales estimates includes the following processes. In the following example, processes of the present invention are discussed in the order described above, in terms of ordered steps. As will be appreciated, the operations described herein as steps can be performed in a number of different orders, and can be combined and divided in a number of ways. These variations are intended to come within the scope of the present invention.

The first step of a method of the present invention applied to this example generates monthly predictions of the TAM for the months of August through December. These predictions can be based on user defined knowledge that is manually entered, or they can be generated by a computation that utilizes available historical TAM values. Table 3 of this example shows monthly TAM predictions generated by linear extrapolation, known to those of ordinary skill in the art, from the historical TAM values shown in Table 2. The practice of this invention is not limited to the use of linear extrapolation for computing TAM predictions. Methods such as exponential smoothing, ARIMA models, and other forecasting techniques known to those of ordinary skill in the art are equally viable approaches.

TABLE 3

| | TAM |
|---|---|
| MONTH | Predictions |
| August | 167 |
| September | 175 |
| October | 184 |
| November | 192 |
| December | 200 |

Table 4 shows ACME's share-of-market (SOM) during the historical months, January through July, and defined as the ratio of ACME's total sales, shown in Table 4, and the TAM. The second step of a method of the present invention applied to this example generates monthly share-of-market predictions for the months of August through December. These predictions are generated by a computation that utilizes available historical SOM values. Table 5 of this example shows monthly SOM predictions that are generated by linear extrapolation, known to those of ordinary skill in the art, from the historical SOM values shown in Table 4. The practice of this invention is not limited to the use of linear extrapolation for computing SOM predictions. Methods such as exponential smoothing, ARIMA models, and other forecasting techniques known to those of ordinary skill in the art are equally viable approaches.

The fourth column of Table 5 also shows that multiplication of the TAM predictions by the SOM predictions produces ACME's total sales predictions for the months of August through December.

Columns two, three, and four of Table 6 show the sales of ACME's three products, A01, A02, and A03 during the historical months of January through July. Column five of Table 6 shows the total monthly sales obtained as the sum over the monthly sales in columns two, three, and four. Columns six, seven, and eight show the percent of total monthly sales of products A01, A02, and A03. Product lifecycle patterns become apparent when historical percent sales is used in contrast to actual sales.

TABLE 4

| MONTH | TAM | ACME Sales Total | SOM |
|---|---|---|---|
| January | 100 | 25 | 0.25 |
| February | 120 | 30 | 0.25 |
| March | 140 | 30 | 0.21 |
| April | 130 | 35 | 0.27 |
| May | 150 | 40 | 0.27 |
| June | 140 | 35 | 0.25 |
| July | 160 | 45 | 0.28 |

TABLE 5

| | SOM | | ACME Total Sales |
|---|---|---|---|
| MONTH | Predictions | TAM Predictions | Predictions |
| August | 0.28 | 167 | 46 |
| September | 0.28 | 175 | 49 |
| October | 0.29 | 184 | 53 |
| November | 0.29 | 192 | 56 |
| December | 0.30 | 200 | 60 |

TABLE 6

| | | | | ACME | A01 | A02 | A03 |
|---|---|---|---|---|---|---|---|
| | A01 | A02 | A03 | Sales | Sales | Sales | Sales |
| MONTH | Sales | Sales | Sales | Total | (%) | (%) | (%) |
| January | 20 | 5 | 0 | 25 | 80% | 20% | 0% |
| February | 21 | 9 | 0 | 30 | 70% | 30% | 0% |
| March | 17 | 13 | 0 | 30 | 57% | 43% | 0% |
| April | 15 | 20 | 0 | 35 | 43% | 57% | 0% |
| May | 13 | 27 | 0 | 40 | 33% | 68% | 0% |
| June | 8 | 24 | 2 | 35 | 23% | 69% | 6% |
| July | 8 | 29 | 8 | 45 | 18% | 64% | 18% |

The third step of a method of the present invention applied to this example generates lifecycle predictions of the percent sales for each product for the months of August through December. These predictions are generated by a computation that utilizes available historical product percent sales values. Table 7 of this example shows monthly product percent sales predictions that are generated by fitting a Bass lifecycle curve, known to those of ordinary skill in the art, to each of the historical product percent sales shown in columns six, seven, and eight of Table 6. The practice of this invention is not limited to the use of Bass lifecycle curves for computing lifecycle predictions. Methods such as exponential smoothing, ARIMA models, and other forecasting techniques known to those of ordinary skill in the art are equally viable approaches.

TABLE 7

| | A01 Sales | A02 Sales | A03 Sales |
|---|---|---|---|
| MONTH | Prediction (%) | Prediction (%) | Prediction (%) |
| August | 11% | 60% | 29% |
| September | 0% | 50% | 50% |
| October | 0% | 34% | 66% |
| November | 0% | 22% | 78% |
| December | 0% | 9% | 91% |

Table 8 of this example shows the baseline sales predictions for each product for the months of August through December, computed by taking the product percent sales predictions in Table 7 and multiplying by the ACME sales predictions in column four of Table 5. The baseline sales predictions are generated without knowledge of ACME's prices or XYZ's competitive product prices. The fourth step of a method of the present invention applied to this example generates monthly product prices for the months of August through December for ACME's and XYZ's products that corresponds to the sales predictions shown in Table 8. We refer to these prices as baseline prices. Table 9 shows the baseline prices for ACME's products A01, A02, and A03 generated by linear extrapolation of ACME's historical product prices shown in Table 2. Table 10 shows the baseline prices for XYZ's products X11, X12, and X13 generated by linear extrapolation of XYZ's historical product prices shown in Table 2. The practice of this invention is not limited to the use linear extrapolation in computing baseline prices. Methods such as exponential smoothing, ARIMA models, and other forecasting techniques known to those of ordinary skill in the art are equally viable approaches.

TABLE 8

| | A01 | | |
|---|---|---|---|
| | Baseline Sales | A02 Baseline Sales | A03 Baseline Sales |
| MONTH | Predictions | Predictions | Predictions |
| August | 5 | 28 | 13 |
| September | 0 | 25 | 25 |
| October | 0 | 18 | 35 |
| November | 0 | 12 | 44 |
| December | 0 | 5 | 54 |

TABLE 9

| | A01 | | |
|---|---|---|---|
| | Baseline Price | A02 Baseline Price | A03 Baseline Price |
| MONTH | Predictions | Predictions | Predictions |
| August | $40 | $76 | $130 |
| September | $31 | $65 | $120 |
| October | $21 | $54 | $110 |
| November | $12 | $43 | $100 |
| December | $3 | $31 | $90 |

TABLE 10

| | X11 | | |
|---|---|---|---|
| | Baseline Price | X12 Baseline Price | X13 Baseline Price |
| MONTH | Predictions | Predictions | Predictions |
| August | $27 | $89 | $110 |
| September | $12 | $77 | $100 |
| October | $0 | $65 | $90 |
| November | $0 | $53 | $80 |
| December | $0 | $41 | $70 |

Multiplication of the monthly baseline sales predictions in Table 8 with the monthly baseline price predictions in Table 9 gives the monthly baseline revenue predictions shown in Table 11 by product and in total. When a company or one of its competitor's planned prices for one or more products in one or more future months differs from the baseline prices for those products and months, the sales of the companies products during those months may and most likely will differ from the computed baseline sales. Table 12 and 13 show the planned prices for ACME and XYZ's products for the future months of August through December. Columns five, six, and seven of Tables 12 and 13 contain the price change for each product from the baseline price computed by taking the plan price for the product for that month and subtracting the baseline price for that product for that month. The planned prices in this example display a stair-case price profile characteristic of many high-technology industries.

TABLE 11

| | A01 | | | |
|---|---|---|---|---|
| | Baseline | A02 Baseline | A03 Baseline | Total Baseline |
| | Revenue | Revenue | Revenue | Revenue |
| MONTH | Prediction | Prediction | Prediction | Prediction |
| August | $205 | $2,097 | $1,733 | $4,035 |
| September | $0 | $1,596 | $2,962 | $4,557 |
| October | $0 | $959 | $3,824 | $4,783 |
| November | $0 | $520 | $4,383 | $4,903 |
| December | $0 | $170 | $4,871 | $5,042 |

TABLE 12

| | A01 | A02 | A03 | | | |
|---|---|---|---|---|---|---|
| | Plan | Plan | Plan | A01 Price | A02 Price | A03 Price |
| MONTH | Price | Price | Price | Change | Change | Change |
| August | $40 | $80 | $120 | $0 | $4 | −$10 |
| September | $30 | $60 | $120 | −$1 | −$5 | $0 |
| October | $20 | $60 | $120 | −$1 | $6 | $10 |
| November | $20 | $40 | $100 | $8 | −$3 | $0 |
| December | $20 | $40 | $100 | $17 | $9 | $10 |

TABLE 13

| | X11 | X12 | X13 | | | |
|---|---|---|---|---|---|---|
| | Plan | Plan | Plan | X11 Price | X12 Price | X13 Price |
| MONTH | Price | Price | Price | Change | Change | Change |
| August | $40 | $80 | $120 | $13 | −$9 | $10 |
| September | $20 | $80 | $110 | $8 | $3 | $10 |
| October | $20 | $50 | $90 | $20 | −$15 | $0 |
| November | $20 | $50 | $80 | $20 | −$3 | $0 |
| December | $10 | $50 | $80 | $10 | $9 | $10 |

The fifth step of a method of the present invention applied to this example uses the price changes for ACME's and XYZ's products to make adjustments to the baseline sales of each ACME product for the months of August through December. These adjustments are termed sales response. One technique for computing the sales response uses a multivariate linear model to compute the sales response of a product from the price changes of the products and competitor's products. The coefficients in this multivariate linear model are termed elasticity coefficientis. In this example, the elasticity coefficients are shown in Table 14 for each ACME product when price changes are made on each ACME and XYZ product. Table 15 shows the computed sales response using the elasticity coefficients in Table 14 and the price changes in Tables 12 and 13. For example, the A01 sales response for August is computed by multiplying the six-element vector formed from the elasticity coefficients in the first column of Table 14 with the six-element vector formed from the August price changes for A01, A02, A03, X11, X12, X13 found in the August row, columns five, six, and seven, in Tables 12 and 13. The practice of this invention is not limited to a multivariate linear model for computing sales response. Methods such as random coefficients models and random utilities models known to those of ordinary skill in the art are equally viable approaches to computing a sales response to price changes.

TABLE 14

| | A01 Sales | A02 Sales | A03 Sales |
|---|---|---|---|
| | Elasticity | Elasticity | Elasticity |
| A01 Price Change | −1 | 0.25 | 0.25 |
| A02 Price Change | 0.5 | −1 | 0.5 |
| A03 Price Change | 0.25 | 0.25 | −1 |
| X11 Price Change | 0.25 | 0.125 | 0.05 |
| X12 Price Change | 0.125 | 0.25 | 0.125 |
| X13 Price Change | 0.05 | 0.125 | 0.25 |

TABLE 15

| | A01 Sales | | |
|---|---|---|---|
| MONTH | Response | A02 Sales Response | A03 Sales Response |
| August | 2.28 | −6.07 | 14.21 |
| September | 1.34 | 7.55 | 0.81 |
| October | 10.26 | −5.53 | −8.02 |
| November | −4.51 | 6.17 | 1.31 |
| December | −6.29 | 2.86 | 2.64 |

The sales responses are computed with respect to the percent sales of each product relative to the total sales of ACME's three products shown in Table 7. The sales responses in Table 15 are added to the baseline sales percent predictions in Table 7 to give the price-adjusted predictions shown in Table 16. These price-adjustments redistribute the percent of total sales of each ACME product in response to the price changes in Tables 12 and 13 from the baseline prices. It is conceivable that the price changes in these two tables also affects the total sales of ACME's three products, and therefore its SOM. The sixth step of a method of the present invention applied to this example uses the price changes for ACME's and XYZ's products to make adjustments to ACME's SOM for the months of August through December. These adjustments are termed SOM responses. One technique for computing the SOM response uses a multivariate linear model to compute the SOM response from the price changes of the products and competitor's products. The coefficients in this multivariate linear model are termed SOM elasticity coefficients. In this example, the SOM elasticity coefficients are shown in Table 17 for the six ACME and XYZ products. Table 18 shows the computed SOM response using the elasticity coefficients in Table 15 and the price changes in Tables 12 and 13. For example, the SOM response for August is computed by multiplying the six-element vector formed from the SOM elasticity coefficients in Table 15 with the six-element vector formed from the August price changes for A01, A02, A03, X11, X12, X13 found in the August row, columns five, six, and seven, in Tables 12 and 13. The practice of this invention is not limited to a multivariate linear model for computing SOM response. Methods such as random coefficients models and random utilities models known to those of ordinary skill in the art are equally viable approaches to computing a SOM response to price changes.

The second column in Table 18 contains the price-adjusted SOM for the months of August through December computed by adding the SOM response in the first column of that table to the SOM predictions in Table 5. The third column in Table 18 contains the TAM predictions also shown in Table 5. The fifth column of Table 18 contains the ACME price-adjusted total sales predictions computed by multiplying the price-adjusted SOM with the TAM predictions for each month. Multiplying each price-adjusted percent sales prediction shown in Table 16 with the price-adjusted total sales predictions in Table 18 gives the price-adjusted sales predictions for each ACME product for the months of August through December shown in Table 19. Finally, Table 20 shows the price-adjusted revenue predictions for each product and each month computed by multiplying the price-adjusted sales predictions in Table 19 with the price plans in Table 12. The fifth column in Table 20 shows the total price-adjusted revenue prediction for ACME for each month computed by summing the price-adjusted revenue predictions of each product for each month. The revenue change shown in the last column of Table 20 is computed by subtracting the total baseline revenue in Table 11 from the total price-adjusted revenue prediction in Table 20.

From the last column in Table 20, we note that the price plans selected in this example and shown in Table 12 and 13 created additional monthly revenue in August, September, and November, and decreased monthly revenues in October and December. Over the five month period, the ACME price plan led to a revenue of $24,197 versus $23,319 using the baseline prices, or a 3.76% improvement.

TABLE 16

| | A01 Price- | | |
|---|---|---|---|
| | adjusted | A02 Price-adjusted | A03 Price-adjusted |
| MONTH | Predictions (%) | Predictions (%) | Predictions (%) |
| August | 13% | 54% | 43% |
| September | 1% | 58% | 51% |
| October | 10% | 28% | 58% |
| November | 0% | 28% | 79% |
| December | 0% | 12% | 94% |

TABLE 17

| | SOM |
|---|---|
| | Elasticity |
| A01 Price | −0.0025 |
| A02 Price | −0.005 |
| A03 Price | −0.0025 |
| X11 Price | 0.00125 |
| X12 Price | 0.00125 |
| X13 Price | 0.00125 |

TABLE 18

| | | Price- | | ACME Price- |
|---|---|---|---|---|
| | SOM | adjusted | TAM | adjusted Total Sales |
| MONTH | Response | SOM | Predictions | Predictions |
| August | 0.02 | 0.30 | 167 | 50 |
| September | 0.05 | 0.33 | 175 | 58 |
| October | −0.05 | 0.24 | 184 | 44 |
| November | 0.01 | 0.31 | 192 | 59 |
| December | −0.07 | 0.22 | 200 | 45 |

TABLE 19

| | A01 | | |
|---|---|---|---|
| | Price-adjusted | A02 Price-adjusted | A03 Price-adjusted |
| MONTH | Sales Predictions | Sales Predictions | Sales Predictions |
| August | 7 | 27 | 21 |
| September | 1 | 34 | 30 |
| October | 5 | 13 | 26 |
| November | 0 | 16 | 47 |
| December | 0 | 5 | 42 |

TABLE 20

| | A01 Price- | A02 Price- | A03 Price- | Total Price- | |
|---|---|---|---|---|---|
| | adjusted | adjusted | adjusted | adjusted | |
| | Revenue | Revenue | Revenue | Revenue | Revenue |
| MONTH | Prediction | Prediction | Prediction | Prediction | Change |
| August | $266 | $2,146 | $2,572 | $4,984 | $950 |
| September | $24 | $2,018 | $3,564 | $5,605 | $1,048 |
| October | $90 | $751 | $3,060 | $3,902 | −$881 |
| November | $0 | $657 | $4,668 | $5,325 | $422 |
| December | $0 | $213 | $4,167 | $4,380 | −$661 |

ACME can repeat the method described using a different price plan in Table 12 for its products and uncovering a different total revenue from sales of its products over the five month period. Using an optimization technique known to those of ordinary skill in the art, ACME can find price plans for its three products for the months of October through December that maximize the total sales revenue.

It may happen that ACME desires to maintain the price of its A03 new product between $100 and $140 for August, September and October, and between $80 and $110 for November and December. Additionally, ACME's inventory may be limited with only 90 A02 units available to sell during period from October through December. ACME now desires to optimize revenue for these five months subject to these business constraints. Observe that the baseline price leads to total sales of 88 A02 units in Table 8 whereas the new price plan for A02 in Table 12 leads to 95 A02 unit sales shown in Table 19. The new price plan would not lead to a feasible solution because it violates the inventory constraint for A02. Using a constrained optimization technique known to those of ordinary skill in the art, ACME can find price plans for its three products for the months of October through December that maximize the total sales revenue and satisfy the stated business constraints.

### An Example Computing and Network Environment

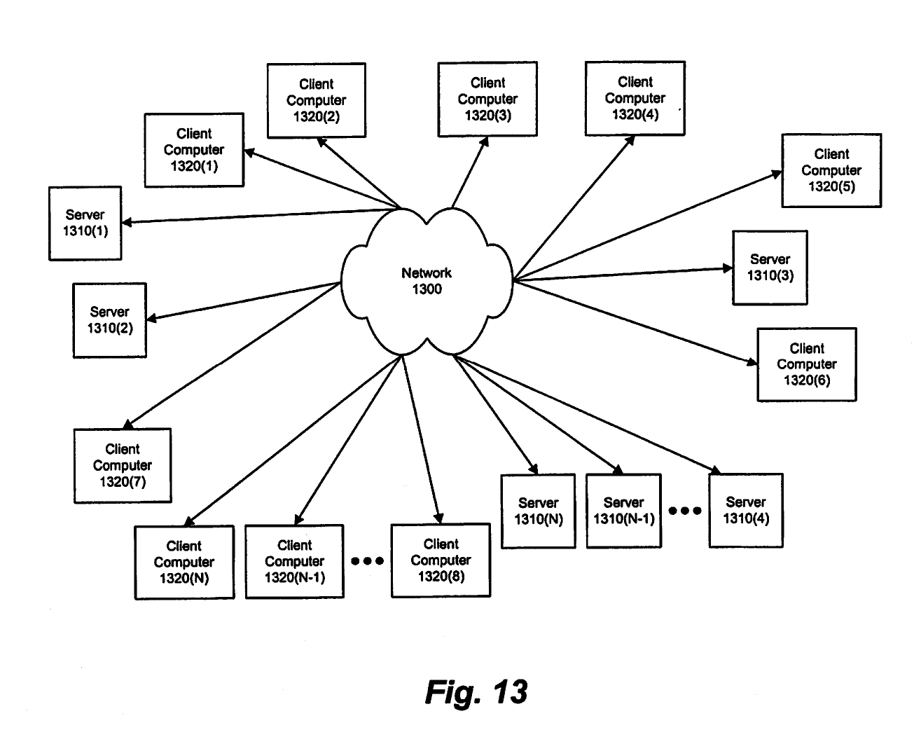

FIG. 13 is a block diagram illustrating a network environment in which a system according to the present invention may be practiced. As is illustrated in FIG. 13, network 1300, such as a private wide area network (WAN) or the Internet, includes a number of networked servers 1310(1)-(N) that are accessible by client computers 1320(1)-(N). Communication between client computers 1320(1)-(N) and servers 1310(1)-(N) typically occurs over a publicly accessible network, such as a public switched telephone network (PSTN), a DSL connection, a cable modem connection or large bandwidth trunks (e.g., communications channels providing T1 or OC3 service). Client computers 1320(1)-(N) access servers 1310(1)-(N) through, for example, a service provider. This might be, for example, an Internet Service Provider (ISP) such as America On-Line™, Prodigy™, CompuServe™ or the like. Access is typically had by executing application specific software (e.g., network connection software and a browser) on the given one of client computers 1320(1)-(N).

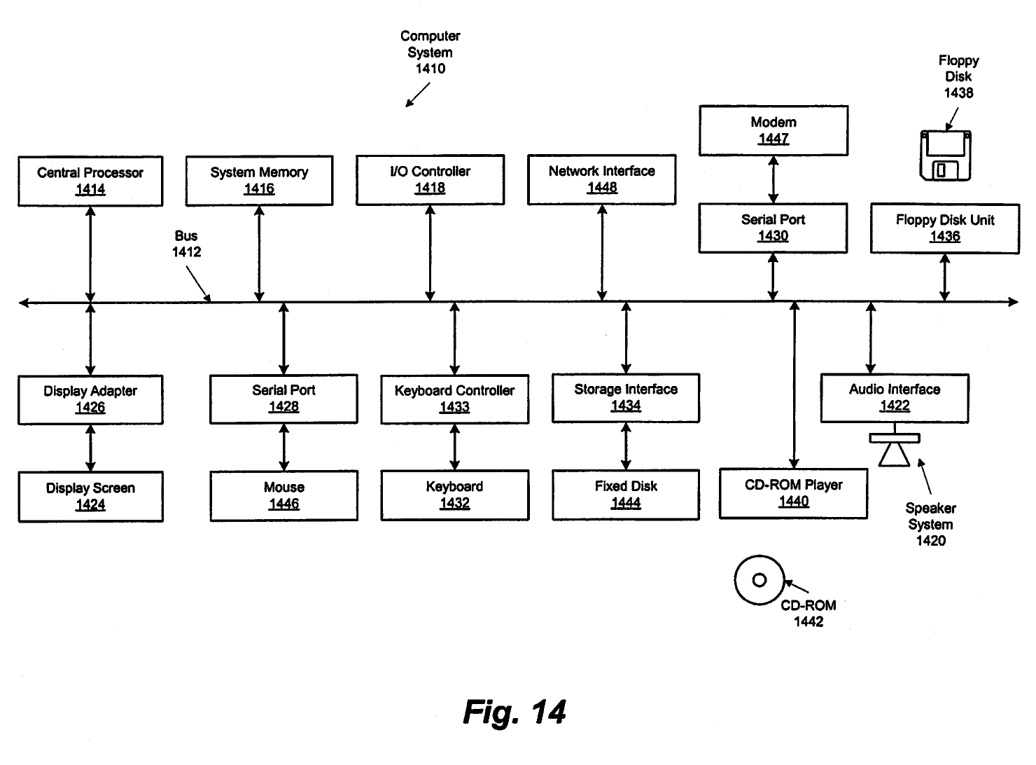

One or more of client computers 1320(1)-(N) and/or one or more of servers 1310(1)-(N) may be, for example, a computer system of any appropriate design, in general, including a mainframe, a mini-computer or a personal computer system. Such a computer system typically includes a system unit having a system processor and associated volatile and non-volatile memory, one or more display monitors and keyboards, one or more diskette drives, one or more fixed disk storage devices and one or more printers. These computer systems are typically information handling systems which are designed to provide computing power to one or more users, either locally or remotely. Such a computer system may also include one or a plurality of I/O devices (i.e., peripheral devices) which are coupled to the system processor and which perform specialized functions. Examples of I/O devices include modems, sound and video devices and specialized communication devices. Mass storage devices such as hard disks, CD-ROM drives and magneto-optical drives may also be provided, either as an integrated or peripheral device. One such example computer system, discussed in terms of client computers 1320(1)-(N) is shown in detail in FIG. 14.

It will be noted that the variable identifier “N” is used in several instances in FIG. 13 to more simply designate the final element (e.g., servers 1310(1)-N and client computers 1320(1)-(N)) of a series of related or similar elements (e.g., servers and client computers). The repeated use of such variable identifiers is not meant to imply a correlation between the sizes of such series of elements, although such correlation may exist. The use of such variable identifiers does not require that each series of elements has the same number of elements as another series delimited by the same variable identifier. Rather, in each instance of use, the variable identified by “N” may hold the same or a different value than other instances of the same variable identifier.

FIG. 14 depicts a block diagram of a computer system 1410 suitable for implementing the present invention, and example of one or more of client computers 1320(1)-(N). Computer system 1410 includes a bus 1412 which interconnects major subsystems of computer system 1410 such as a central processor 1414, a system memory 1416 (typically RAM, but which may also include ROM, flash RAM, or the like), an input/output controller 1418, an external audio device such as a speaker system 1420 via an audio output interface 1422, an external device such as a display screen 1424 via display adapter 1426, serial ports 1428 and 1430, a keyboard 1432 (interfaced with a keyboard controller 1433), a storage interface 1434, a floppy disk drive 1436 operative to receive a floppy disk 1438, and a CD-ROM drive 1440 operative to receive a CD-ROM 1442. Also included are a mouse 1446 (or other point-and-click device, coupled to bus 1412 via serial port 1428), a modem 1447 (coupled to bus 1412 via serial port 1430) and a network interface 1448 (coupled directly to bus 1412).

Bus 1412 allows data communication between central processor 1414 and system memory 1416, which may include both read only memory (ROM) or flash memory (neither shown), and random access memory (RAM) (not shown), as previously noted. The RAM is generally the main memory into which the operating system and application programs are loaded and typically affords at least 136 megabytes of memory space. The ROM or flash memory may contain, among other code, the Basic Input-Output system (BIOS) which controls basic hardware operation such as the interaction with peripheral components. Applications resident with computer system 1410 are generally stored on and accessed via a computer readable medium, such as a hard disk drive (e.g., fixed disk 1444), an optical drive (e.g., CD-ROM drive 1440), floppy disk unit 1436 or other storage medium. Additionally, applications may be in the form of electronic signals modulated in accordance with the application and data communication technology when accessed via network modem 1447 or interface 1448.

Storage interface 1434, as with the other storage interfaces of computer system 1410, may connect to a standard computer readable medium for storage and/or retrieval of information, such as a fixed disk drive 1444. Fixed disk drive 1444 may be a part of computer system 1410 or may be separate and accessed through other interface systems. Many other devices can be connected such as a mouse 1446 connected to bus 1412 via serial port 1428, a modem 1447 connected to bus 1412 via serial port 1430 and a network interface 1448 connected directly to bus 1412. Modem 1447 may provide a direct connection to a remote server via a telephone link or to the Internet via an internet service provider (ISP). Network interface 1448 may provide a direct connection to a remote server via a direct network link to the Internet via a POP (point of presence). Network interface 1448 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., bar code readers, document scanners, digital cameras and so on). Conversely, it is not necessary for all of the devices shown in FIG. 14 to be present to practice the present invention. The devices and subsystems may be interconnected in different ways from that shown in FIG. 14. The operation of a computer system such as that shown in FIG. 14 is readily known in the art and is not discussed in detail in this application. Code to implement the present invention may be stored in computer-readable storage media such as one or more of system memory 1416, fixed disk 1444, CD-ROM 1442, or floppy disk 1438. Additionally, computer system 1410 may be any kind of computing device, and so includes personal data assistants (PDAs), network appliance, X-window terminal or other such computing device. The operating system provided on computer system 1410 may be MS-DOS®, MS-WINDOWS®, OS/2®, UNIX®, Linux® or other known operating system. Computer system 1410 also supports a number of Internet access tools, including, for example, an HTTP-compliant web browser having a JavaScript interpreter, such as Netscape Navigator® 15.0, Microsoft Explorer® 15.0 and the like.

Moreover, regarding the signals described herein, those skilled in the art will recognize that a signal may be directly transmitted from a first block to a second block, or a signal may be modified (e.g., amplified, attenuated, delayed, latched, buffered, inverted, filtered or otherwise modified) between the blocks. Although the signals of the above described embodiment are characterized as transmitted from one block to the next, other embodiments of the present invention may include modified signals in place of such directly transmitted signals as long as the informational and/or functional aspect of the signal is transmitted between blocks. To some extent, a signal input at a second block may be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

The foregoing described embodiment wherein the different components are contained within different other components (e.g., the various elements shown as components of computer system 1410). It is to be understood that such depicted architectures are merely examples, and that in fact many other architectures can be implemented which achieve the same functionality. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality.

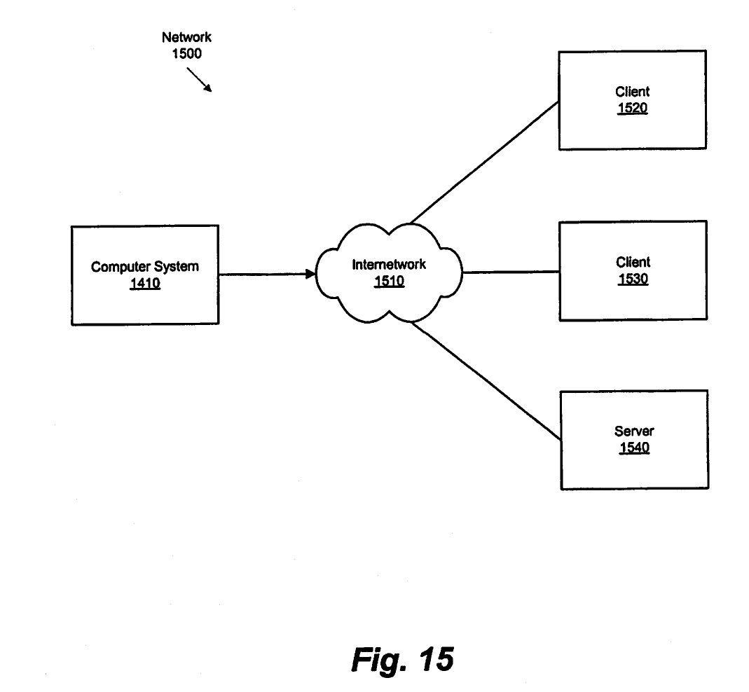

FIG. 15 is a block diagram depicting a network 1500 in which computer system 1410 is coupled to an internetwork 1510, which is coupled, in turn, to client systems 1520 and 1530, as well as a server 1540. Internetwork 1510 (e.g., the Internet) is also capable of coupling client systems 1520 and 1530, and server 1540 to one another. With reference to computer system 1410, modem 1447, network interface 1448 or some other method can be used to provide connectivity from computer system 1410 to internetwork 1510. Computer system 1410, client system 1520 and client system 1530 are able to access information on server 1540 using, for example, a web browser (not shown). Such a web browser allows computer system 1410, as well as client systems 1520 and 1530, to access data on server 1540 representing the pages of a website hosted on server 1540. Protocols for exchanging data via the Internet are well known to those skilled in the art. Although FIG. 15 depicts the use of the Internet for exchanging data, the present invention is not limited to the Internet or any particular network-based environment.

Referring to FIGS. 13, 14 and 15, a browser running on computer system 1410 employs a TCP/IP connection to pass a request to server 1540, which can run an HTTP “service” (e.g., under the WINDOWS® operating system) or a “daemon” (e.g., under the UNIX® operating system), for example. Such a request can be processed, for example, by contacting an HTTP server employing a protocol that can be used to communicate between the HTTP server and the client computer. The HTTP server then responds to the protocol, typically by sending a “web page” formatted as an HTML file. The browser interprets the HTML file and may form a visual representation of the same using local resources (e.g., fonts and colors).

While particular embodiments of the present invention have been shown and described, it will be obvious to those skilled in the art that, based upon the teachings herein, changes and modifications may be made without departing from this invention and its broader aspects and, therefore, the present invention encompasses within its scope all such changes and modifications as are within the true spirit and scope of the present invention.

What is claimed is:

1. A computer-implemented method comprising:
producing optimized prices for products for sale.
